(19) United States
(12) Patent Application Publication
(10) Pub. No.: US 2026/0052028 A1
(43) Pub. Date: Feb. 19, 2026

(54) CRYPTOGRAPHIC ATTESTATION OF DATA OBJECT ATTRIBUTES IN A DISTRIBUTED SYSTEM

(71) Applicant: Fortanix, Inc., Santa Clara, CA (US)

(72) Inventors: Mohsen Zohrevandi, Fremont, CA (US); James Allen Hagborg, Quincy, MA (US); Jethro Gideon Beekman, Eindhoven (NL); Xinyu Lin, San Jose, CA (US); Yuxiang Cao, San Jose, CA (US)

(21) Appl. No.: 18/808,861

(22) Filed: Aug. 19, 2024

(51) Int. Cl. H04L 9/32

(52) U.S. Cl. CPC H04L 9/3268; H04L 9/3247

(57) ABSTRACT

A request to provide a data object attestation authority certificate to a second cluster of secure environments is received at a first cluster of secure environments. The request comprises a cluster certificate of the second cluster issued by a cluster enrollment certificate authority (CA). The cluster certificate is validated using a public key of the enrollment CA. An encrypted message comprising the attestation authority certificate and a digital signature of the first cluster is generated. The encrypted message is encrypted using a public key indicated in the cluster certificate of the second cluster. The digital signature is associated with a cluster certificate of the first cluster issued by the enrollment CA. The encrypted message is provided to the second cluster to be decrypted using a private key associated with the cluster certificate of the second cluster, and to be validated using at least the public key of the enrollment CA.

### TECHNICAL FIELD

Aspects and embodiments of the present disclosure relate to distributed systems, and in particular to cryptographic attestation of data object attributes in a distributed system.

### BACKGROUND

A digital certificate may include a statement linking a public key with an identity of an entity such as an individual, organization, or device. Certificates may further include a validity period specifying when the certificate is valid, a digital signature of the certificate issuer (e.g., a digital signature signed by the certificate issuer), or other information. A Certificate Authority (CA) issues digital certificates. A CA may possess a CA certificate that allows the CA to issue other certificates, and that indicates the CA's public key. The CA may use a corresponding private key to sign the contents of issued certificates (e.g., the CA may sign the whole certificate, or a key or other component of the certificate). Certificates and CAs may be part of a public key infrastructure (PKI), which facilitates the creation, distribution, usage, storage, revocation, and other operations on certificates for various applications. An X.509 certificate is an example of a digital certificate.

### BRIEF DESCRIPTION OF DRAWINGS

Various embodiments in accordance with the present disclosure will be described with reference to the drawings, in which:

FIGS. 1A-B are block diagrams of an example system architecture for providing cryptographic attestation of data object attributes in a distributed system, in accordance with an embodiment;

FIG. 2A is a block diagram of an example public key infrastructure for providing cryptographic attestation of data object attributes in a distributed system, in accordance with an embodiment;

FIG. 2B is a block diagram of an example public key infrastructure for providing cryptographic attestation of data object attributes in a distributed system, in accordance with an embodiment;

FIG. 3 is a block diagram of an example encrypted message for sharing a data object attestation authority certificate between clusters of a distributed data object attestation system, in accordance with an embodiment;

FIG. 4 is a block diagram of an example data object attestation, in accordance with an embodiment;

FIGS. 5A-B are a flow diagram of an example method for providing cryptographic attestation of data object attributes in a distributed system, in accordance with an embodiment;

FIG. 5C is a flow diagram of an example method for enrolling a cluster in a distributed data object attestation system, in accordance with an embodiment;

FIG. 5D is a flow diagram of an example method for obtaining a data object attestation authority certificate from a distributed attestation certificate authority, in accordance with an embodiment;

FIG. 6A is a flow diagram of an example method for sharing data objects between clusters of a distributed system, in accordance with an embodiment;

FIG. 6B is a flow diagram of an example method for sharing data objects between secure environments of a distributed system, in accordance with an embodiment;

FIG. 7 illustrates an example network server having a secure environment for providing cryptographic attestation of data object attributes in a distributed system; and

FIG. 8 illustrates an example computer system, in accordance with an embodiment.

### DETAILED DESCRIPTION

Aspects and embodiments of the present disclosure relate to cryptographic attestation of data object attributes in a distributed system. A cryptographic attestation is a statement with an associated digital signature of a trusted entity. Digital certificates are an example of cryptographic attestations. A certificate may include a statement linking a public key with an identity of an entity such as an individual, organization, or device. Certificates may further include a validity period specifying when the certificate is valid, a digital signature of the certificate issuer, or other information. Other cryptographic attestations may include other statements and related information. Attestation Authorities (AAs) are entities that issue (e.g., generate and sign) cryptographic attestations. A Certificate Authority (CA) is an example of an AA that issues digital certificates. A CA may possess a CA certificate that allows the CA to issue other certificates, and that indicates the CA's public key. The CA may use a corresponding private key to sign the contents of issued certificates. Certificates and CAs may be part of a public key infrastructure (PKI), which facilitates the creation, distribution, usage, storage, revocation, and other operations on certificates for various applications. For example, a PKI may include a root CA, which may be trusted by relevant entities, and which may possess a self-signed CA certificate. The root CA may issue CA certificates to establish other CAs in the PKI (e.g., intermediate CAs), and various CAs may further issue end-user certificates (e.g., leaf certificates) for user entities. End-user certificates may not provide the certificate issuing authority of CA certificates but may provide other statements useful to user entities. User entities may trace a chain of certificates from the end-user certificate back to the root CA. Thus, any certificate issued by a CA within the PKI may be trusted to the same extent as a certificate issued by the root CA. An X.509 certificate is an example of a digital certificate.

In some systems, hardware security modules (HSMs) may be used as CAs or other AAs. An HSM may be a hardware appliance such as a server, a PCIe card, a trusted platform module (TPM), a USB hardware wallet, or a similar device that provides a secure environment. HSMs may perform various functions such as generating and securely storing keys, generating digital signatures, etc. Using an HSM as a CA may contribute in part to the trustworthiness of the CA due to the HSM's secure environment. An HSM participating as a CA in a PKI may receive a request to issue a certificate from a user entity using a request protocol such as the Certificate Signing Request (CSR) protocol, the Certificate Management Protocol (CMP), or similar. The HSM may sign the certificate using a private key securely stored within the HSM, where the associated public key has been certified by a higher CA as described above (unless the HSM is the root CA). The user requesting the certificate can make claims about the statement(s) in the certificate to other entities based on shared trust of the CA(s). A similar process may be used for other types of cryptographic attestations.

The above-described systems may face several challenges related to providing cryptographic attestations for data objects stored in a secure environment such as an HSM. For example, a user entity may want to generate or store a data object (e.g., a key or secret) in a secure environment. The user may further want to set attributes (e.g., permissions) for how the data object may be used, whether the data object may be exported from the secure environment, or similar. Users may have various purposes for these data objects and attributes, such as for satisfying an internal security policy or meeting security requirements of an external (e.g., third party) service. The user may want to obtain a cryptographic attestation from the secure environment to prove the location and attributes of the data object for these or other purposes. However, provisioning data objects within a single secure environment and obtaining cryptographic attestations from the same secure environment may present various risks. For example, using a single HSM to manage data objects and to issue cryptographic attestations regarding those data objects presents a single point of failure. Should the HSM fail or otherwise become unavailable, the user may be unable to use the data objects stored in the HSM and may be unable to obtain cryptographic attestations related to the data objects. Furthermore, the identity, location, contents (e.g., the data objects), or other characteristics of the HSM may be revealed through cryptographic attestations issued by the HSM, which may expose the HSM to malicious activity or decrease the trustworthiness of the HSM due to its non-anonymous nature.

Another challenge faced by the above-described systems relates to the availability and performance of secure environments issuing cryptographic attestations. In an example scenario, two HSMs may each manage data objects. The first HSM may be able to issue cryptographic attestations regarding its managed data objects, but the first HSM may be unable to issue cryptographic attestations regarding data objects managed by the second HSM. This may be due to the first HSM's lack of necessary information about the second HSM's data objects to issue cryptographic attestations or the inability of the two HSMs to establish a trustworthy medium for securely exchanging this information. Thus, the two HSMs may be unable to balance attestation request loads when one HSM is experiencing significantly more attestation requests than the other. Furthermore, the first HSM may be unable to serve attestation requests from entities that are geographically close to it (or otherwise close, e.g., with regard to network latency) when the relevant data objects are stored in the second HSM on another continent (or otherwise distant, e.g., with regard to network latency).

As a result of these and other challenges, secure environments managing data objects and issuing cryptographic attestations regarding the data objects may experience uneven loads on computing resources and increased risk of data breach or loss. Users of secure environments may experience excessive latency and unavailability of data objects or attestation services. Entities using or managing secure environments may thus experience increased costs, liabilities, interruptions, and other negative impacts.

Aspects of the present disclosure address the above and other deficiencies by providing cryptographic attestation of data object attributes in a distributed system. In an embodiment, clusters are enrolled in a distributed data object management and attestation system. A cluster may include one or more secure environments. For example, a cluster may include a single HSM node or multiple software-based secure environment nodes. A cluster enrollment CA of the distributed system may validate properties of each cluster and issue cluster certificates to conformant clusters. Examples of validations that the cluster enrollment CA may perform include validating the authenticity of the secure environment(s) of a cluster (e.g., by receiving a certificate issued by the manufacturer) and validating that the cluster is properly configured. Enrolled clusters may thus be trusted to perform various data object management and attestation operations on behalf of the distributed system.

In an embodiment, a cluster of a distributed data object management and attestation system is provisioned as a data object AA. A distributed attestation CA of the distributed system may validate properties of the cluster and issue a data object AA certificate to the conformant cluster, enabling the cluster to issue data object attestations as a data object AA. An example validation that the distributed attestation CA may perform is validating that the cluster is an enrolled cluster (e.g., by receiving a cluster certificate issued by a cluster enrollment CA). The provisioned data object AA may thus be trusted to issue attestations regarding data objects managed in the cluster.

In an embodiment, a first cluster provisioned as a data object AA in a distributed data object management and attestation system may share its data object AA certificate with a second enrolled cluster of the distributed system. For example, the first cluster may encrypt the data object AA certificate using a public key of the second cluster's cluster certificate and may sign the data object AA certificate (or a key or other component thereof) using a private key associated with the public key of the first cluster's cluster certificate. Thus, both clusters may confirm each other's identity as an enrolled cluster and, subsequent to the exchange of the data object AA certificate, may each issue data object attestations under the same authority for data objects managed by either cluster. In an embodiment, a similar technique may be used for exchanging data objects between clusters (when data object permissions allow), enabling each cluster to perform operations on or with the same data objects.

Accordingly, systems using the techniques described herein can provide distributed management and attestation of data objects across multiple clusters of secure environments, enabling the clusters to share loads to mitigate single points of failure. Furthermore, users requesting operations on data objects or attestations of data objects may experience decreased latency when requests are served by a geographically close cluster and may experience increased availability when other clusters and secure environments cover for unavailable clusters and secure environments. Security and trustworthiness of secure environments may be further improved by the distributed nature of systems using these techniques. For example, because a data object attestation may be issued by any cluster, it may be difficult to determine which cluster manages the data object of the attestation. Thus, entities using or managing secure environments may experience reduced costs, liabilities and interruptions, and may address other negative impacts associated with conventional data object management and attestations.

### System Architecture

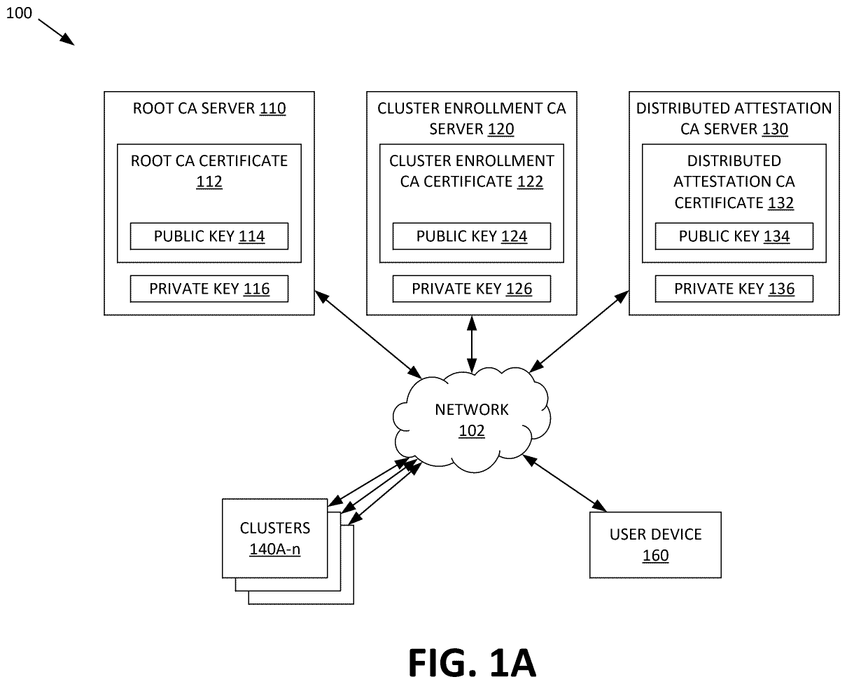

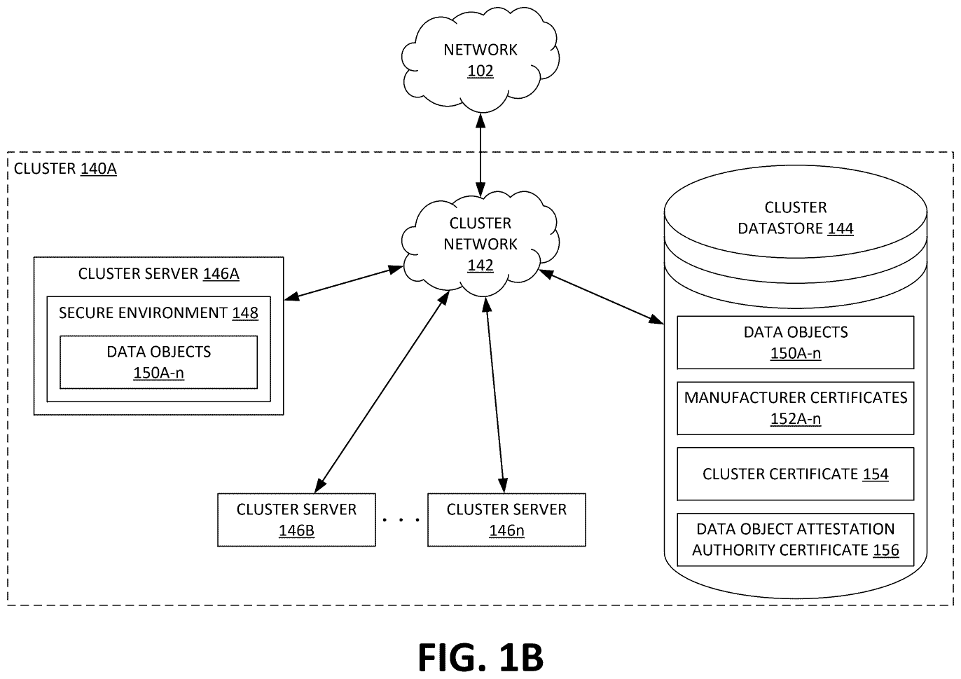

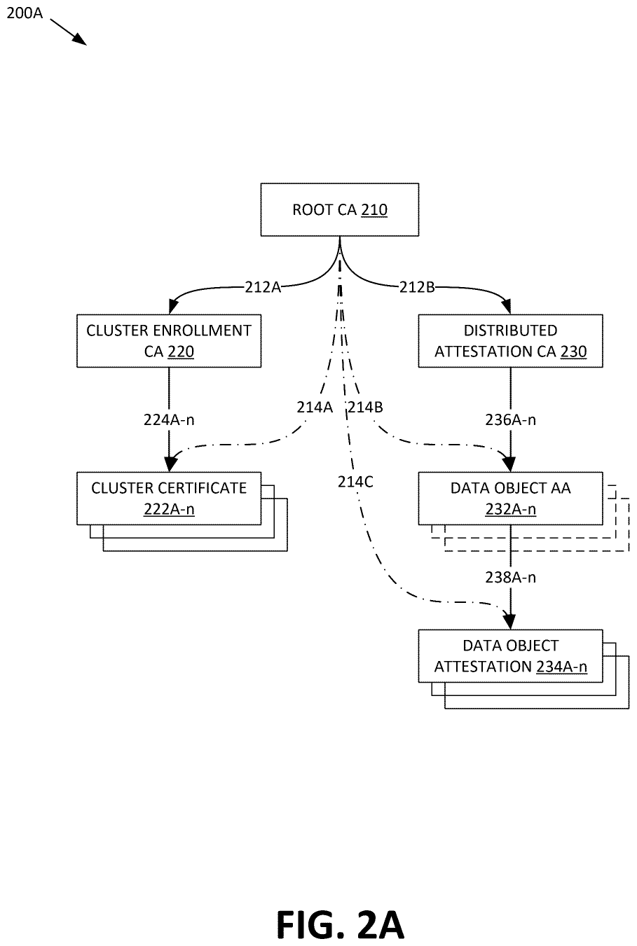

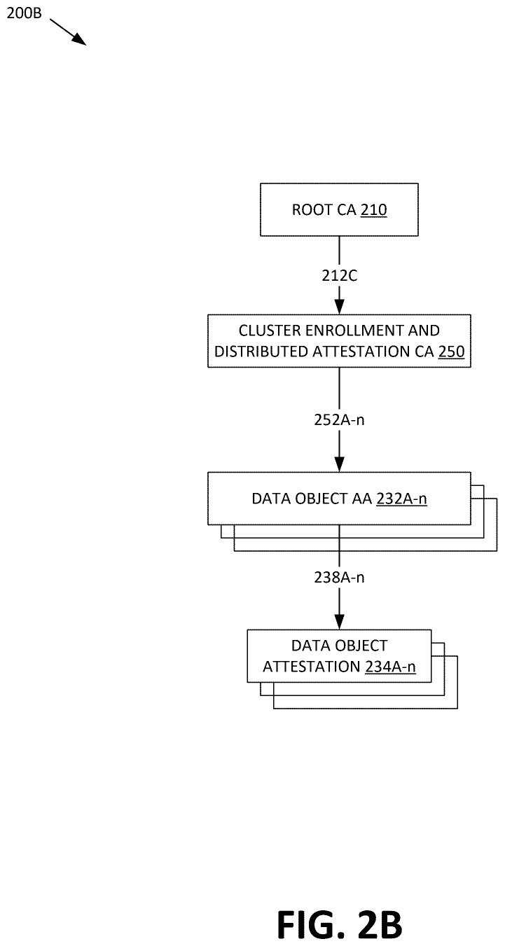

FIG. 1A is a block diagram of an example system architecture 100 for providing cryptographic attestation of data object attributes in a distributed system, in accordance with an embodiment. System architecture 100 (also referred to as “system” herein) includes network 102 root CA server 110, cluster enrollment CA server 120, distributed attestation CA server 130, clusters 140A-n, and user device 160. Clusters 140A-n are further described with reference to FIG. 1B. Various servers, CAs, and certificates of FIG. 1A may form a PKI for system 100 (e.g., as described with reference to FIG. 2).

Network 102 may include a public network (e.g., the Internet), a private network (e.g., a LAN, a WAN, a VPN, an enterprise network), a wired network (e.g., Ethernet), a wireless network (e.g., an 802.11 Wi-Fi network), a cellular network (e.g., a 5G network), routers, hubs, switches, server computers, or a combination thereof. For example, network 102 may include a plurality of the above types of networks connected together via a VPN, the Border Gateway Protocol (BGP), or other protocol. Network 102 or components thereof may be associated with different organizations in various embodiments. For example, components of network 102 may be associated with Internet Service Providers (ISPs), mobile or cellular carriers, cloud platform or software-as-a-service (SaaS) providers, private or public enterprises, private households or communities, etc. In an embodiment, network 102 (or a component thereof) may be a physical or virtual interconnect within a single device, such as a PCIe bus, a messaging system, or an API.

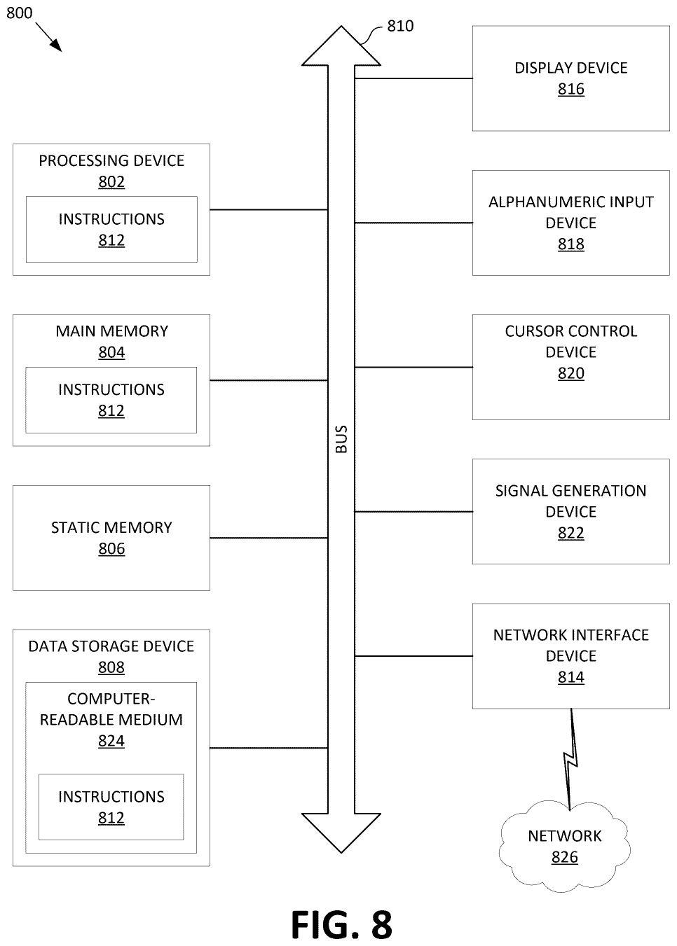

Each of servers 110-130 and user device 160 may be a personal computer (PC), a laptop computer, a notebook computer, a mobile phone, a smartphone, a tablet computer, a digital assistant, a rackmount server, a router computer, or similar computing device. An example computing device is further described with reference to FIG. 8. Each of servers 110-130 and user device 160 may also be a virtualized resource such as a virtual machine (VM) or a containerized application. Each of servers 110-130 and user device 160 may also correspond to a collection of physical or virtual computing resources, such as a datacenter or a collection of servers or VMs distributed across multiple data centers. For example, servers 110-130 may correspond to cloud computing resources provisioned from a cloud computing provider. Each of servers 110-130 and user device 160 may run an operating system or one or more software applications.

Root CA server 110 includes root CA certificate 112 linking public key 114 to root CA server 110. Public key 114 may be associated with private key 116. For example, keys 114-116 may be a key pair of a digital signing algorithm or other cryptographic algorithm (e.g., RSA, ECDSA). In various embodiments, root CA certificate 112 may be self-signed by root CA server 110 or may be signed by another CA outside system 100 (not depicted). Root CA server 110 may thus be a root CA of system 100 and may be trusted by entities and devices associated with system 100. In various embodiments, root CA server 110 may issue cluster enrollment CA certificate 122, distributed attestation CA certificate 132, or other certificates for system 100.

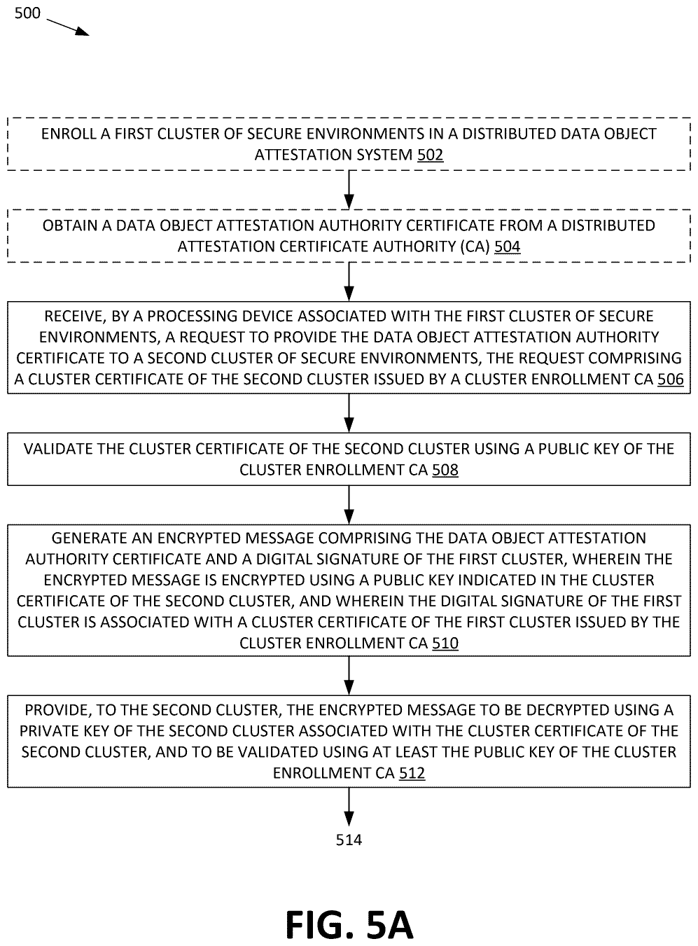

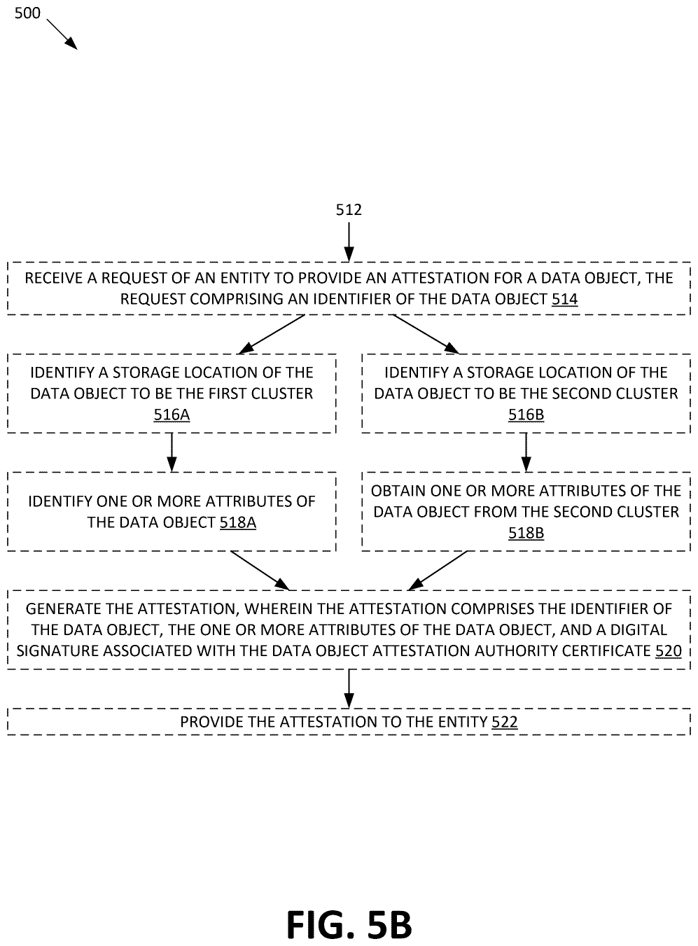

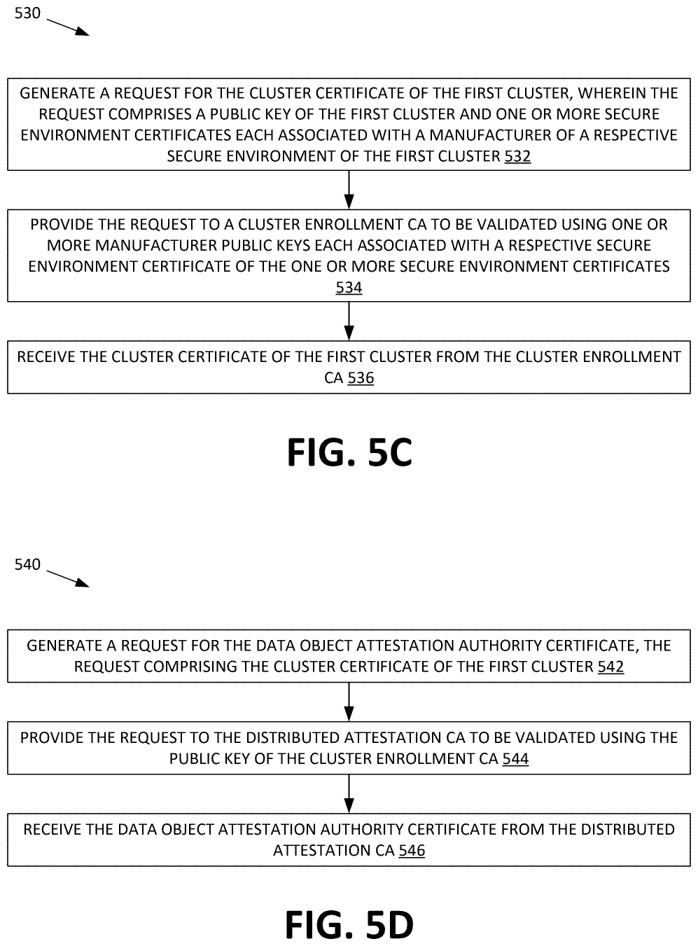

Cluster enrollment CA server 120 includes cluster enrollment CA certificate 122 linking public key 124 to cluster enrollment CA server 120. Public key 124 may be associated with private key 126 (e.g., similar to keys 114-116 previously described). In various embodiments, cluster enrollment CA certificate 122 may be signed by root CA server 110, may be self-signed by cluster enrollment CA server 120, or may be signed by another CA outside system 100 (not depicted). Cluster enrollment CA server 120 may validate characteristics of clusters 140A-n and may enroll conformant clusters in system 100 by issuing cluster certificates as described with reference to FIG. 5C. Cluster certificates may thus be traced through a certificate chain to a trusted entity, such as cluster enrollment CA server 120 or root CA server 110. In an embodiment, cluster enrollment CA server 120 may issue other certificates for system 100.

Distributed attestation CA server 130 includes distributed attestation CA certificate 132 linking public key 134 to distributed attestation CA server 130. Public key 134 may be associated with private key 136 (e.g., similar to keys 114-116 previously described). In various embodiments, distributed attestation CA certificate 132 may be signed by root CA server 110, may be self-signed by distributed attestation CA server 130, or may be signed by another CA outside system 100 (not depicted). Distributed attestation CA server 130 may validate enrollment of clusters 140A-n and may provision clusters as data object AAs in system 100 by issuing data object AA certificates as described with respect to FIG. 5D. Data object AA certificates may thus be traced through a certificate chain to a trusted entity, such as distributed attestation CA server 130 or root CA server 110. In an embodiment, distributed attestation CA server 130 may issue other certificates for system 100.

In an embodiment, certificates may have various levels of importance, security requirements, or other characteristics relative to other certificates. For example, root CA certificate 112 may be the most important or critical certificate of system 100 because all other certificates may be traceable to root CA certificate 112. Root CA certificate 112 may have a longer validity period than other certificates in system 100. Root CA certificate 112 may thus have a higher level of security and provisioning requirements than other certificates. For example, root CA certificate 112 and keys 114-116 may be provisioned using a manual process (e.g., a provisioning ceremony), may be stored in a secure environment, may be limited to issuing certain certificates (e.g., certificates 122 and 132), etc. Root CA server 110 may be required to be disconnected from network 102 or may be required to implement specific firewall settings to protect private key 116. In other examples, various certificates may be provisioned using manual or automatic procedures, may impose various requirements on their respective servers, may have various validity periods and issuance rules/frequencies, or similar.

In an embodiment, various servers, CAs, and certificates of FIG. 1A may be absent or combined. For example, a single server may serve as a root CA, a cluster enrollment CA, and a distributed attestation CA, and may possess the relevant CA certificates and key pairs for these roles. In another example, root CA certificate 112 may be absent, and certificates 122 and 132 may be self-signed or issued by a CA external to system 100. In another example, the cluster enrollment CA and distributed attestation CA roles may be merged, such that a single CA enrolls clusters and provisions them as data object AAs with a single certificate. Various other PKI architectures may be used in various embodiments.

In an embodiment, CA certificates 112-132 and other certificates issued by the respective CAs may be various types of certificates or may be other types of attestations. For example, root CA certificate 112 may be a root certificate, cluster enrollment CA certificate 122 may be an intermediate root certificate, and issued cluster certificates may be end-user (e.g., leaf) certificates that do not issue further certificates. Certificates/attestations may include other statements in addition to or in place of statements linking keys to identities.

User device 160 may be associated with a user entity that generates, stores, and performs other operations on data objects using system 100. The user, through user device 160, may further request data object attestations in relation to the data objects of system 100. The user may communicate with clusters 140A-n for these purposes and may obtain certificates 112-132 from servers 110-130 or other sources (e.g., certificates may be posted on the Internet) for validating attestations issued by clusters 140A-n. The user may use the attestations to prove attributes of the data objects to other devices and entities (not depicted). The other devices and entities may similarly obtain certificates 112-132 to validate the attestations. In an embodiment, system 100 may include multiple users or user devices.

FIG. 1B is a block diagram of an example cluster of secure environments 140A of system architecture 100. Cluster 140A includes cluster network 142, cluster datastore 144, and one or more cluster servers 146A-n. Cluster network 142 may include routers or other network infrastructure as described with respect to network 102 and may interface cluster 140A and components thereof (e.g., datastore 144, cluster servers 146A-n) with network 102. For example, cluster 140A may correspond to a data center and cluster network 142 may correspond to a data center LAN connected to the Internet.

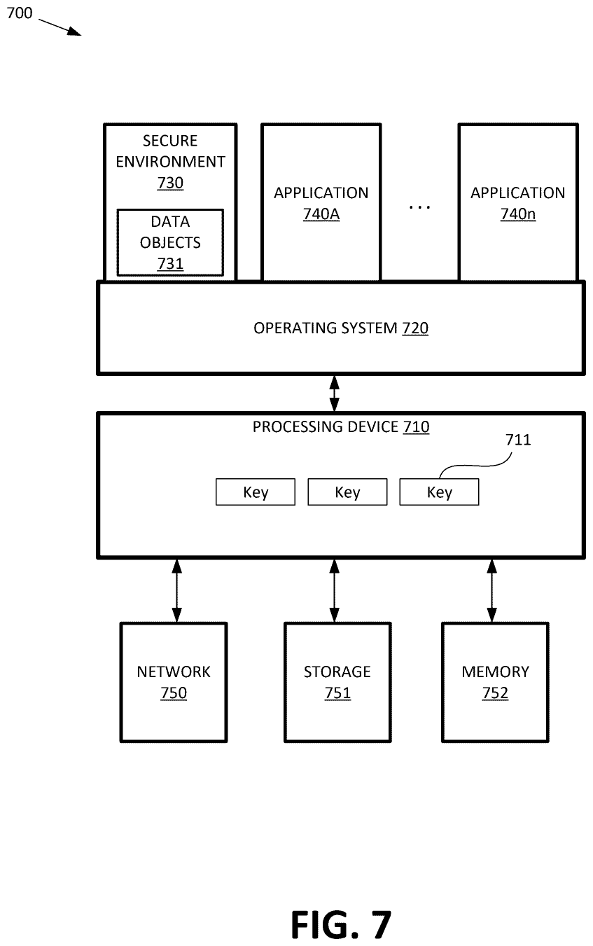

Cluster servers 146A-n may each be various types of computing devices as described with reference to servers 110-130, user device 160, and FIGS. 7-8. Cluster servers 146A-n may have similar characteristics and configurations relative to other cluster servers 146A-n or may have different characteristics and configurations. Aspects described with respect to example cluster server 146A may or may not apply to cluster servers 146B-n in various embodiments.

Cluster server 146A includes secure environment 148. Secure environment 148 may provide various protections and guarantees with respect to data stored within or code executed within secure environment 148. For example, secure environment 148 may prevent unauthorized entities from viewing or altering stored data or code. Unauthorized entities may include external users and devices as well as cluster server 146A itself and any software executing thereon (e.g., an operating system, third-party applications). Secure environment 148 may use hardware-based techniques for providing various protections, such as by providing instruction set architecture (ISA) extensions that initiate secure hardware-based operations, storing keys and other data objects in a hardware-based storage component that is inaccessible to software, encrypting portions of memory-based hardware-stored keys, and similar. Secure environment 148 may be associated with a digital certificate issued by a manufacturer of secure environment 148, which may be used to validate characteristics, configurations, statuses, etc. of secure environment 148. Such manufacturer certificates are further described below. Examples of secure environments that may be included in cluster server 146A include hardware security modules (HSMs), trusted platform modules (TPMs), trusted execution environments (TEEs), secure elements (SEs), Intel Software Guard Extensions (SGX), or other hardware- or software-based secure environments. An example system having a secure environment is further described with reference to FIG. 7. In an embodiment, cluster server 146A may have no secure environments or may have multiple secure environments (e.g., multiple HSM PCIe cards, or multiple software-based secure environments backed by TEEs, SGX, etc.).

Cluster server 146A further includes one or more data objects 150A-n stored in secure environment 148. A data object may be associated with an entity (e.g., user device 160) and may include information managed by system 100 or components thereof (e.g., cluster 140A or cluster server 146A). Examples of information of data objects include cryptographic keys, secrets, one-time pads, sensitive data, logs/records, or other types of information. Data objects may further include attributes related to the data object and information therein. Attributes may include metadata such as when and where the data object was generated, where the data object is currently located, when the data object expires, who owns the data object, etc. Attributes may further include permissions, such as for what purposes the data object may be used, whether the data object may be exported from the secure environment where it is stored, and similar. In an example scenario, user device 160 may send a request to cluster server 146A with instructions to generate a public/private key pair data object and to store the private key in secure environment 148. The request may further set permissions that prohibit the private key from being exported from secure environment 148 and that permit the private key to be used for signing specific documents but not for other documents. User device 160 may later provide a document to cluster server 146A with instructions to sign the document using the private key. Secure environment 148 may be configured to perform the signing operation without exposing the private key to cluster server 146A or software thereon. User device 160 may further request an attestation from cluster 140A, as described herein, indicating that the private was generated and stored in secure environment 148, that it is not exportable, and that it is restricted for use in signing specific documents. User device 160 may provide the signed document and attestation to third parties for various purposes (e.g., to access a service).

In an embodiment, data objects 150A-n may additionally or alternatively be included in cluster datastore 144. For example, data objects 150A-n can be stored encrypted at rest in cluster datastore 144 and moved/copied to secure environment 148 for decryption and use. When finished operating on data objects 150A-n, secure environment 148 can (re) encrypt data objects 150A-n and move/copy data objects 150A-n to cluster datastore 144.

In an embodiment, cluster server 146A may be a primary server of cluster 140A, and cluster servers 146B-n may be secondary servers. For example, cluster server 146A may communicate with external entities (e.g., servers 110-130 or user device 160) and may provide instructions to and receive results from cluster servers 146B-n. In an embodiment, cluster servers 146A-n may be peer servers. For example, cluster servers 146A-n may share responsibility for managing cluster 140A and may respond to external communications based on various types of load balancing and job scheduling (e.g., round-robin, first-come first-served, etc.).

Cluster datastore 144 may include one or more persistent storage devices such as magnetic tapes or drives, solid-state drives, optical drives or similar (e.g., other storage technologies described with reference to FIG. 8). Cluster datastore 144 may also include storage devices in a networked topology, such as a Storage Area Network (SAN), Network-Attached Storage (NAS), cloud-provisioned storage, or similar. Cluster datastore 144 may be shared by cluster servers 140A-n, or cluster 140A may include multiple cluster datastores 144 each associated with a respective cluster server(s). For example, cluster servers 146A-n may each have internal storage. In an embodiment, cluster datastore 144 may be some other type of persistent storage such as an object-oriented database, a relational database, a key-value store, and so forth, that may be hosted by cluster servers 140A-n or one or more different machines coupled to cluster network 142.

Cluster datastore 144 includes manufacturer certificates 152A-n, cluster certificate 154, and data object AA certificate 156. Manufacturer certificates 152A-n may correspond to cluster servers 146A-n or secure environments thereof. A manufacturer certificate may contain one or more statements related to characteristics of the respective secure environment and may be signed by a CA of the manufacturer. Manufacturer certificates 152A-n may be provided by cluster 140A to cluster enrollment CA server 120 or other entity to prove the characteristics or configurations of cluster 140A's secure environments. Cluster certificate 154 may be received from cluster enrollment CA server 120 in response to validation of cluster 140A (e.g., using provided manufacturer certificates 152A-n). Cluster certificate 154 may indicate that cluster 140A is compliant with various requirements to be enrolled in system 100, such as having properly configured secure environments, having appropriate software and resources to manage data objects, etc. Cluster certificate 154 may be provided by cluster 140A to distributed attestation CA server 130 or other entity to prove the membership of cluster 140A in system 100. Data object AA certificate 156 may be received from distributed attestation CA server 130 in response to validation of cluster 140A (e.g., using provided cluster certificate 154). Data object AA certificate may enable cluster 140A to issue data object attestations to various entities (e.g., user device 160) for their respective data objects of data objects 150A-n.

In an embodiment, data objects 150A-n or certificates 152-156 may be distributed throughout components of cluster 140A. For example, data objects 150A-n may be divided between cluster servers 146A-n (e.g., for load-balancing purposes) or may be duplicated across cluster servers 146A-n (e.g., for redundancy or load-balancing purposes). In the latter example, some data objects may be restricted by permission attributes to being generated and stored within a single secure environment (e.g., secure environment 148), some data objects may be permitted to be stored at and moved between various secure environments of cluster 140A but may be restricted from export outside cluster 140A, and some data objects may be unrestricted for storage and transport within or external to cluster 140A. In another example, each of cluster servers 146A-n may store their respective manufacturer certificate of manufacturer certificates 152A-n. In another example, each of cluster servers 146A-n may store a copy of certificates 154-156 and may use or provide certificates 154-156 for external communication as peer servers based on respective loads. Other storage configurations, permissions, and load balancing techniques may be used in various embodiments.

FIG. 2A is a block diagram of an example PKI 200A for providing cryptographic attestation of data object attributes in a distributed system, in accordance with an embodiment. PKI 200A includes root CA 210, cluster enrollment CA 220, one or more cluster certificates 222A-n, distributed attestation CA 230, one or more data object AAs 232A-n, and one or more data object attestations 234A-n.

Root CA 210 may correspond to root CA server 110 or root CA certificate 112 of FIG. 1. Root CA 210 may be the root CA of PKI 200A and may be self-signed and trusted by entities participating in or relying on PKI 200A. Root CA 210 may have a longer validity period than other CAs and certificates within PKI 200A and may be associated with security requirements designed to maintain the integrity and trustworthiness of root CA 210 throughout the validity period. Root CA 210 may be provisioned by a manual or automatic process. Root CA 210 may issue other CAs and certificates, such as cluster enrollment CA 220 and distributed attestation CA 230 (e.g., relationships 212A-B). In an embodiment, a security requirement for root CA 210 may prevent root CA 210 from issuing certificates (or other types of attestations) other than intermediate CAs (e.g., relationships 214A-C, as indicated by dashed lines, may be absent). In an embodiment, root CA 210 may issue other certificates and attestations within PKI 200A (e.g., relationships 214A-C).

Cluster enrollment CA 220 may correspond to cluster enrollment CA server 120 or cluster enrollment CA certificate 122. Cluster enrollment CA 220 may be an intermediate CA of PKI 200A and may be signed by root CA 210 (e.g., relationship 212A). Cluster enrollment CA 220 may be associated with various validity periods, security requirements, provisioning processes, and other characteristics as previously described with reference to other CAs. Cluster enrollment CA 220 may issue one or more cluster certificates 222A-n (e.g., relationships 224A-n, cluster certificate 154) to respective clusters within PKI 200A (e.g., clusters 140A-n). Cluster enrollment CA 220 may validate various characteristics and configurations of clusters before issuing cluster certificates 222A-n. Validation may include receiving data from the clusters (e.g., manufacturer certificates 152A-n), participating in various validation protocols with the clusters, or other validation techniques.

Distributed attestation CA 230 may correspond to distributed attestation CA server 130 or distributed attestation CA certificate 132. Distributed attestation CA 230 may be an intermediate CA of PKI 200A and may be signed by root CA 210 (e.g., relationship 212B). Distributed attestation CA 230 may be associated with various validity periods, security requirements, provisioning processes, and other characteristics as previously described with reference to other CAs. Distributed attestation CA 230 may issue one or more data object AAs 232A-n (e.g., relationships 236A-n) to respective clusters within PKI 200A (e.g., clusters 140A-n). Distributed attestation CA 230 may validate various characteristics and configurations of clusters before issuing data object AAs 232A-n. For example, distributed attestation CA 230 may validate that clusters are enrolled by cluster enrollment CA 220 and possess respective cluster certificates of cluster certificates 222A-n. In an embodiment, distributed attestation CA 230 may issue a single data object AA 232A (e.g., data object AAs 232B-n, as indicated by dashed lines, may be absent) or may issue fewer data object AAs than there are clusters within PKI 200A, and clusters may share the issued data object AA(s) using the techniques described with reference to FIGS. 5A-D to provide a unified data object AA within PKI 200A. In an embodiment, distributed attestation CA 230 may issue respective data object AAs 232A-n to each cluster.

Data object AA 232A may correspond to cluster 140A or data object AA certificate 156. Data object AA 232A may be an intermediate CA/AA of PKI 200A and may be signed by distributed attestation CA 230 or root CA 210 (e.g., relationships 212B and 214B). Data object AA 232 may be associated with various validity periods, security requirements, provisioning processes, and other characteristics as previously described with reference to other CAs. Data object AA 232A may issue one or more data object attestations 234A-n (e.g., relationships 238A-n) to users (e.g., user device 160) in association with respective data objects managed by clusters within PKI 200A (e.g., data objects 150A-n). Data object AA 232A may identify a storage location or various attributes of a data object before issuing a data object attestation. In an embodiment, a cluster acting as data object AA 232A may identify another cluster sharing data object AA 232A as being a storage location of a data object and may obtain various attributes of the data object from the other cluster before issuing a data object attestation. Various aspects described with reference to data object AA 232A may apply to data object AAs 232B-n in embodiments having more than one data object AA.

FIG. 2B is a block diagram of an example PKI 200B for providing cryptographic attestation of data object attributes in a distributed system, in accordance with an embodiment. PKI 200B includes root CA 210, cluster enrollment and distributed attestation CA 250, one or more data object AAs 232A-n, and one or more data object attestations 234A-n. Various components of PKI 200B may correspond to aspects described with reference to PKI 200A. In an embodiment, cluster enrollment and distributed attestation CA 250 may perform functions described with reference to cluster enrollment CA 220 and distributed attestation CA 230. For example, cluster enrollment and distributed attestation CA 250 may validate prospective clusters (e.g., by receiving manufacturer certificates) and may issue data object AAs 232A-n (e.g., relationships 252A-n) to simultaneously enroll clusters and provision them as data object AAs. Cluster enrollment and distributed attestation CA 250 may be signed by root CA 210 (e.g., relationship 212C), may be self-signed (e.g., may be the root CA of PKI 200B), or may be signed by another CA not depicted.

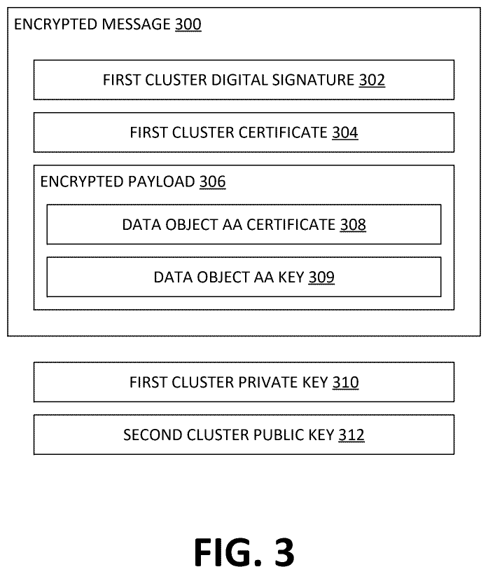

FIG. 3 is a block diagram of an example encrypted message 300 for sharing a data object AA certificate between clusters of a distributed data object attestation system, in accordance with an embodiment. Message 300 may be generated by a first cluster (e.g., cluster 140A of FIG. 1A) and provided to a second cluster (e.g., cluster 140B). In various embodiments, message fields depicted in FIG. 3 may be absent or other fields not depicted may be present. For example, first cluster certificate 304 may be absent and may be obtained by the second cluster in another communication. In another example, additional identifying information of the first or second cluster may be included in message 300.

Encrypted message 300 includes first cluster digital signature 302, which may be generated by the first cluster using first cluster private key 310. Encrypted message 300 further includes first cluster certificate 304, which may be cluster certificate 154 and which may include a public key corresponding to first cluster private key 310. Cluster certificate 304 may be used by the second cluster to validate the origin and integrity of encrypted message 300.

Encrypted message 300 includes encrypted payload 306, which further includes data object AA certificate 308 and/or data object AA key 309. Data object AA certificate 308 may be certificate 156. Data object AA key 309 may be a key associated with data object AA certificate 308 (e.g., a private key), which may be used to sign a data object attestation. Certificate 308 and key 309 may be encrypted in encrypted payload 306 using second cluster public key 312, which may be obtained by the first cluster from a cluster certificate of the second cluster. In an embodiment, digital signature 302, cluster certificate 304, or other fields may be included within encrypted payload 306.

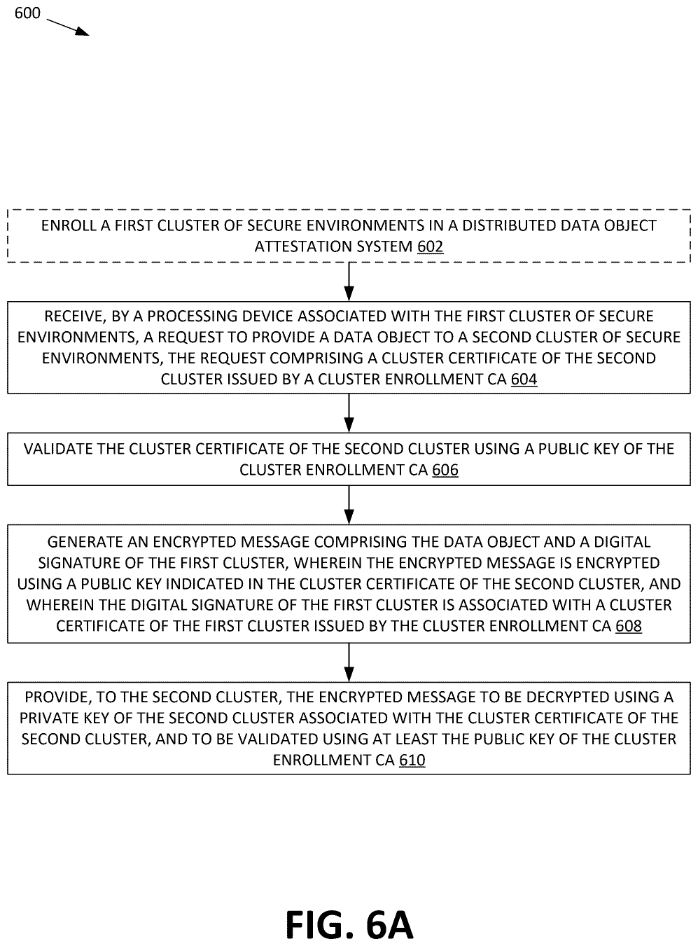

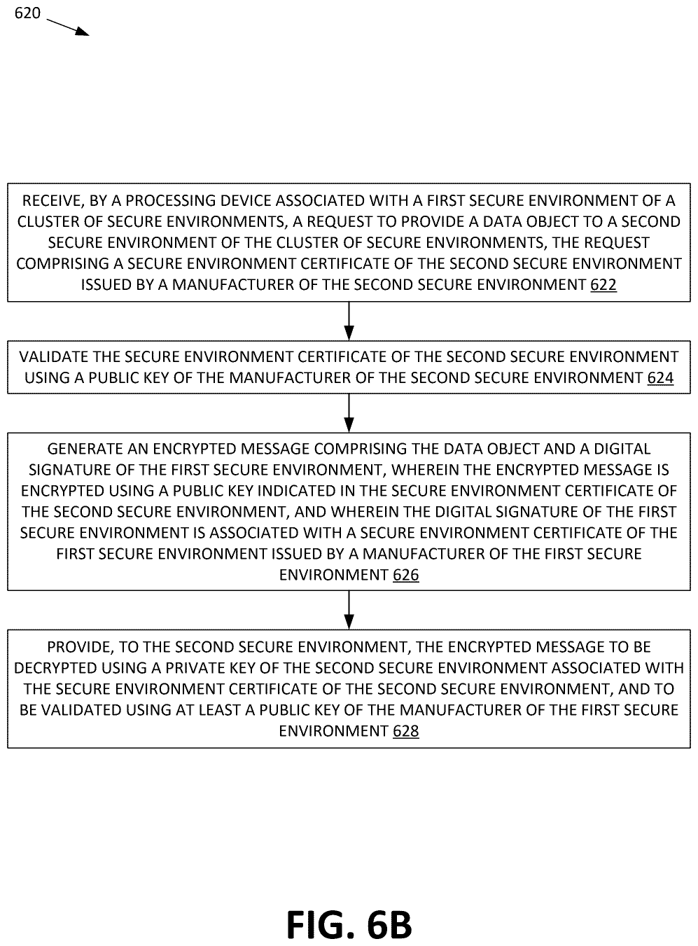

Methods for sharing data object AAs between two or more clusters are further described with reference to FIGS. 5A-D. In an embodiment, encrypted message 300 may further be used to share data objects between clusters by replacing data object AA certificate 308 with a data object (e.g., one of data objects 150A-n). A method for sharing data objects between two or more clusters is further described with reference to FIG. 6A. In an embodiment, encrypted message 300 may further be used to share data objects between secure environments within a cluster or in different clusters by replacing data object AA certificate 308 with a data object and by replacing cluster certificates and associated keys with secure environment certificates and associated keys. A method for sharing data objects between two or more secure environments is further described with reference to FIG. 6B.

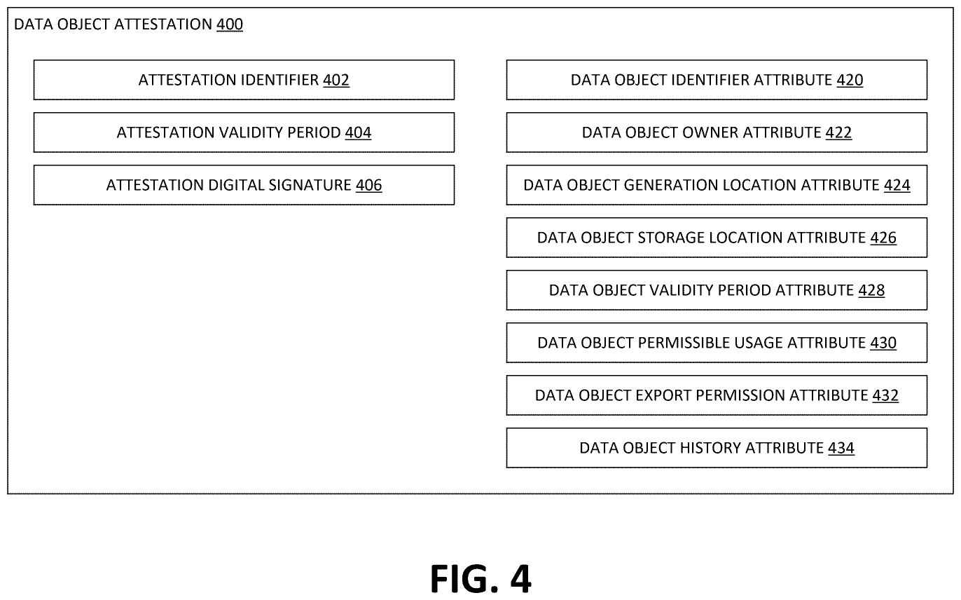

FIG. 4 is a block diagram of an example data object attestation 400 (also referred to as “attestation” herein), in accordance with an embodiment. Attestation 400 may correspond to data object attestations 234A-n of FIGS. 2A-B. Attestation 400 may be issued by data object AA 232A or a respective cluster (e.g., cluster 140A). Attestation 400 includes various fields 402-406 associated with the attestation itself and various fields 420-432 associated with a corresponding data object. In various embodiments, fields depicted in FIG. 4 may be absent or other fields not depicted may be present. Attestation 400 may conform to different formats in various embodiments. For example, attestation 400 may conform to the X.509 certificate format.

Attestation identifier 402 may be a unique or non-unique identifier of data object attestation 400, such as a universally unique identifier (UUID). Attestation identifier 402 may be generated by the issuing data object AA or may be provided to the issuing data object AA by another entity (e.g., user device 160).

Attestation validity period 404 may be one or more indicators of generation time or expiration time of data object attestation 400. For example, attestation validity period 404 may include and generation timestamp, an expiration timestamp, or a lifetime delta value (e.g., number of units of time after generation for which attestation 400 is valid). Attestation validity period 404 may be generated by the issuing data object AA or may be provided to the issuing data object AA by another entity.

Attestation digital signature 406 may be a digital signature of the issuing data object AA (e.g., using a private key associated with certificate 156 or AA 232A). An entity may prove the origin and integrity of attestation 400 by validating digital signature 406 using higher-level CA certificates in a certificate chain up to the root CA of the system.

Data object identifier attribute 420 may be a unique or non-unique identifier of a corresponding data object, such as a UUID.

Data object owner attribute 422 may be a unique or non-unique identifier of an owner entity of a corresponding data object, such as an owner name, contact information, UUID, combinations of the above, or similar.

Data object generation location attribute 424 may indicate a cluster, cluster server, secure environment, user device, or other location where a corresponding data object was generated. Attribute 424 may include an identifier of the location (e.g., UUID, etc.), a certificate associated with the location (e.g., a manufacturer certificate), or similar.

Data object generation storage attribute 426 may indicate a cluster, cluster server, secure environment, user device, or other location where a corresponding data object is stored before, at, or after attestation 400 is generated. Attribute 426 may include an identifier of the location (e.g., UUID, etc.), a certificate associated with the location (e.g., a manufacturer certificate), or similar.

Data object validity period attribute 428 may be one or more indicators of generation time or expiration time of a corresponding data object. For example, validity period attribute 428 may include and generation timestamp, an expiration timestamp, or a lifetime delta value (e.g., number of units of time after generation for which the corresponding data object is valid).

Data object permissible usage attribute 430 may indicate one or more permissible uses for a corresponding data object. For example, usage attribute 430 may indicate that a data object (e.g., a key) can be used for signing documents or encrypting data. In an embodiment, usage attribute 430 may indicate one or more restricted uses for a corresponding data object (e.g., uses for which the data object may not be used). Data object permissible uses and restricted uses may be enforced by the system (e.g., by clusters managing data objects).

Data object export permission attribute 432 may indicate whether a corresponding data object may be exported or removed from a storage location. For example, export permission attribute 432 may indicate that a data object cannot be exported from the secure environment where it was generated, from the cluster where it was generated, or from the distributed system. In the latter two examples, the data object may be moved or copied between secure environments of a cluster or between clusters of the distributed system, respectively, without violating the export permissions. Export permission attribute 432 may further specify secure methods for moving/copying data objects in these scenarios (e.g., as described with reference to FIGS. 6A-B). In another example, export permission attribute 432 may indicate that a data object may be freely exported from the system.

Data object history attribute 434 may indicate one or more events associated with a corresponding data object, such as logs or records of activity. For example, history attribute 434 may indicate what the data object has been used for, how many times the data object has been used, where the data object has been stored, how many times the data object has been moved or copied, or similar. History attribute 434 may further include identifiers of entities, locations, data, or other relevant facts associated with data object history. For example, history attribute 434 may include an identifier of a user requesting a usage of the data object, the type of usage requested, other data associated with the usage, where the usage was performed, etc. History attribute 434 may further include timestamps corresponding to the events.

### Cryptographic Attestation of Data Object Attributes

FIGS. 5A-B are a flow diagram of an example method 500 for providing cryptographic attestation of data object attributes in a distributed system, in accordance with an embodiment. Method 500 may be performed by processing logic that may comprise hardware (e.g., circuitry, dedicated logic, etc.), computer-readable instructions such as software or firmware (e.g., run on a general-purpose computing system or a dedicated machine), or a combination thereof. For instance, an example system may include a memory and a processing device coupled to the memory device to perform operations comprising the blocks of method 500. Method 500 may also be associated with a set of instructions stored on a non-transitory computer-readable medium (e.g., magnetic or optical disk, etc.). The instructions, when executed by a processing device, may cause the processing device to perform operations comprising the blocks of method 500. In an embodiment, method 500 is performed by the system of FIGS. 1A-B or components thereof (e.g., servers 110-130, clusters 140A-n, cluster servers 146A-n, secure environment 148, user device 160). In an embodiment, method 500 is performed by computing system 800 of FIG. 8. In some embodiments, blocks depicted in FIGS. 5A-B could be performed simultaneously or in a different order than depicted. Various embodiments may include additional blocks not depicted in FIGS. 5A-B or a subset of blocks depicted in FIGS. 5A-B. For example, blocks depicted with a dashed outline (e.g., blocks 502-504) may be absent in an embodiment.

At block 502, processing logic associated with a first cluster of secure environments enrolls the first cluster in a distributed data object attestation system. The first cluster may be cluster 140A of FIGS. 1A-B, and the secure environments may include secure environment 148. An example method for enrolling the first cluster in the distributed data object attestation system is further described with reference to FIG. 5C.

At block 504, the processing logic obtains a data object attestation authority (AA) certificate from a distributed attestation certificate authority (CA). The data object AA certificate may be data object AA certificate 156 of FIG. 1, and the distributed attestation CA may be distributed attestation CA server 130 or distributed attestation CA 230. An example method for obtaining the data object AA certificate from the distributed attestation CA is further described with reference to FIG. 5D.

At block 506, the processing logic receives a request to provide the data object AA certificate to a second cluster of secure environments, the request comprising a cluster certificate of the second cluster issued by the cluster enrollment CA. The second cluster may be one of clusters 140B-n, the cluster certificate may be a corresponding cluster certificate of cluster certificates 222A-n (e.g., a cluster certificate analogous to cluster certificate 154 of cluster 140A), and the cluster enrollment CA may be cluster enrollment CA server 120 or cluster enrollment CA 220. The first and second clusters may be peer clusters enrolled in a distributed system (e.g., each using method 530), and sharing the data object AA certificate may enable the clusters to issue data object attestations under the same authority. The request may originate from the second cluster or may originate from another entity (e.g., various components of FIGS. 1-2) in various embodiments.

In an embodiment, the first cluster or the second cluster may receive a second request to provide the data object AA certificate to a third cluster of secure environments, the request comprising a cluster certificate of the third cluster issued by the cluster enrollment CA. Method 500 may continue with respect to the third cluster and the recipient of the request to bring more clusters under the same data object AA.

At block 508, the processing logic validates the cluster certificate of the second cluster using a public key of the cluster enrollment CA. The public key of the cluster enrollment CA may be public key 124 and may correspond to a private key of the cluster enrollment CA (e.g., private key 126). The cluster enrollment CA may use the private key to sign the cluster certificate (or a key or other component thereof) of the second cluster, and the cluster certificate may thus be validated using the public key. The public key may be obtained from the cluster enrollment CA (e.g., by obtaining a copy of its CA certificate) or from another entity or location (e.g., the CA certificate may be posted on the internet). Additional certificates and public keys may be obtained to verify certificates in a certificate chain leading to a root CA (e.g., root CA server 110 or root CA 210). In an embodiment, other validations may be performed. For example, the processing logic may engage in a validation protocol with the first cluster, the second cluster, the cluster enrollment CA, or other entity.

At block 510, the processing logic generates an encrypted message comprising the data object AA certificate and a digital signature of the first cluster, wherein the encrypted message is encrypted using a public key indicated in the cluster certificate of the second cluster, and wherein the digital signature of the first cluster is associated with a cluster certificate of the first cluster issued by the cluster enrollment CA. The encrypted message may be encrypted message 300 of FIG. 3. The cluster certificate of the first cluster may be cluster certificate 154 of cluster 140A. The digital signature may be generated using a private key corresponding to a public key indicated in the cluster certificate of the first cluster. The order of encrypting and signing the encrypted message may be different in various embodiments.

At block 512, the processing logic provides, to the second cluster, the encrypted message to be decrypted using a private key of the second cluster associated with the cluster certificate of the second cluster, and to be validated using at least the public key of the cluster enrollment CA. The private key of the second cluster may correspond to the public key of the second cluster indicated in its cluster certificate. In an embodiment, the encrypted message is to be further validated using at least the cluster certificate of the first cluster. For example, the second cluster, in response to receiving the encrypted message, may decrypt the message and may verify that the message originated with the first cluster by validating the signature using the cluster certificate of the first cluster. The cluster certificate of the first cluster may further be validated using the public key of the cluster enrollment CA to confirm that the first cluster is enrolled in the system. In an embodiment, the second cluster may further validate the data object AA certificate from the decrypted message using a public key of a distributed attestation CA to confirm that the data object AA certificate was issued by that CA. In various embodiments, the order of decrypting the message, validating the message signature, validating the cluster certificate of the first cluster, and validating the data object AA certificate (when these various steps are present) may be different.

At block 514, the processing logic receives a request of an entity to provide an attestation for a data object, the request comprising an identifier of the data object. The entity may be user device 160, a user associated with user device 160, or other entity. The data object may be one of data objects 150A-n and may be associated with the entity. For example, the entity may be the owner of the data object or may have requested the data object to be generated. The identifier of the data object may be a UUID or other examples discussed with respect to FIG. 4.

In an embodiment, the data object comprises one or more of: a permissible usage attribute indicating for what purposes the data object may be used (e.g., attribute 430), an origination attribute indicating whether the data object was generated in a secure environment of the first cluster (e.g., attribute 424), or an export attribute indicating whether the data object may be exported from the first cluster (e.g., attribute 432).

In an embodiment, the data object may be stored in the first cluster (e.g., in a secure environment of the first cluster). At block 516A, the processing logic identifies a storage location of the data object to be the first cluster. For example, the processing logic may identify a secure environment (e.g., secure environment 148) of the first cluster to be the storage location of the data object. The processing logic may consult a data object index of the cluster (e.g., stored in cluster datastore 144), may query secure environments within the cluster, or may use other methods to identify the storage location of the data object. At block 518A, the processing logic identifies one or more attributes of the data object. For example, the processing logic may identify one or more of attributes 420-434 described with reference to FIG. 4. The attributes may be stored with the data object (e.g., in a secure environment, as data object metadata) or may be stored separate from the object (e.g., in a cluster datastore, in a centralized data object metadata database).

In an embodiment, the data object may be stored in the second cluster (e.g., in a secure environment of the second cluster). At block 516B, the processing logic identifies a storage location of the data object to be the second cluster. For example, the processing logic may consult a data object index of the cluster or system indicating resident clusters for various data object identifiers. In another example, the processing logic may query peer clusters to identify the storage location of the data object. Block 516B may be performed subsequent to a determination that the data object is not stored in the first cluster. At block 518B, the processing logic obtains one or more attributes of the data object from the second cluster (e.g., attributes 420-434 as previously described). For example, the processing logic may request the attributes from the second cluster identified in block 516B or may receive the attributes as part of a response to a storage location query of block 516B.

At block 520, the processing logic generates the attestation, wherein the attestation comprises the identifier of the data object, the one or more attributes of the data object, and a digital signature associated with the data object AA certificate. The attestation may be data object attestation 400 of FIG. 4, and the identifier and the one or more attributes may be attributes 420-434. The digital signature may be attestation digital signature 406 and may be generated using a private key corresponding to a public key indicated in the data object AA certificate. In an embodiment, where the data object is stored at the second cluster as in blocks 516B-518B, the attestation may be generated at the first cluster or may be generated at the second cluster and provided to the first cluster. At block 522, the processing logic provides the attestation to the entity.

FIG. 5C is a flow diagram of an example method 530 for enrolling the first cluster of method 500 in the distributed data object attestation system, in accordance with an embodiment. Method 530 may correspond to block 502 of method 500. Method 530 may be performed by processing logic that may comprise hardware (e.g., circuitry, dedicated logic, etc.), computer-readable instructions such as software or firmware (e.g., run on a general-purpose computing system or a dedicated machine), or a combination thereof. For instance, an example system may include a memory and a processing device coupled to the memory device to perform operations comprising the blocks of method 530. Method 530 may also be associated with a set of instructions stored on a non-transitory computer-readable medium (e.g., magnetic or optical disk, etc.). The instructions, when executed by a processing device, may cause the processing device to perform operations comprising the blocks of method 530. In an embodiment, method 530 is performed by the system of FIGS. 1A-B or components thereof (e.g., servers 110-130, clusters 140A-n, cluster servers 146A-n, secure environment 148, user device 160). In an embodiment, method 530 is performed by computing system 800 of FIG. 8. In some embodiments, blocks depicted in FIG. 5C could be performed simultaneously or in a different order than depicted. Various embodiments may include additional blocks not depicted in FIG. 5C or a subset of blocks depicted in FIG. 5C.

At block 532, processing logic generates a request for the cluster enrollment certificate of the first cluster, wherein the request comprises a public key of the first cluster and one or more secure environment certificates each associated with a manufacturer of a respective secure environment of the first cluster. The secure environment certificates may be manufacturer certificates 152A-n of FIG. 1B. The public key of the first cluster may correspond to a public-private key pair generated or stored at the first cluster.

At block 534, the processing logic provides the request to a cluster enrollment CA (e.g., cluster enrollment CA server 120 or cluster enrollment CA 220) to be validated using one or more manufacturer public keys each associated with a respective secure environment certificate of the one or more secure environment certificates. For example, the cluster enrollment CA may obtain a manufacturer public key from a manufacturer (e.g., via the manufacturer's website) for each manufacturer of one or more of the secure environments and may validate the manufacturer's digital signature in the corresponding secure environment certificate(s) using the public key. In an embodiment, other validations may be performed by the cluster enrollment CA. For example, the processing logic may engage in a validation protocol with the first cluster, the cluster enrollment CA, or other entity. At block 536, the processing logic receives the cluster certificate of the first cluster from the cluster enrollment CA.

FIG. 5D is a flow diagram of an example method 540 for obtaining the data object AA certificate of method 500 from the distributed attestation CA, in accordance with an embodiment. Method 540 may correspond to block 504 of method 500. Method 540 may be performed by processing logic that may comprise hardware (e.g., circuitry, dedicated logic, etc.), computer-readable instructions such as software or firmware (e.g., run on a general-purpose computing system or a dedicated machine), or a combination thereof. For instance, an example system may include a memory and a processing device coupled to the memory device to perform operations comprising the blocks of method 540. Method 540 may also be associated with a set of instructions stored on a non-transitory computer-readable medium (e.g., magnetic or optical disk, etc.). The instructions, when executed by a processing device, may cause the processing device to perform operations comprising the blocks of method 540. In an embodiment, method 540 is performed by the system of FIGS. 1A-B or components thereof (e.g., servers 110-130, clusters 140A-n, cluster servers 146A-n, secure environment 148, user device 160). In an embodiment, method 540 is performed by computing system 800 of FIG. 8. In some embodiments, blocks depicted in FIG. 5D could be performed simultaneously or in a different order than depicted. Various embodiments may include additional blocks not depicted in FIG. 5D or a subset of blocks depicted in FIG. 5D.

At block 542, processing logic generates a request for the data object AA certificate, the request comprising the cluster certificate of the first cluster. The cluster certificate may be the cluster certificate obtained in method 530. At block 544, the processing logic provides the request to the distributed attestation CA to be validated using the public key of the cluster enrollment CA. For example, the distributed attestation CA may validate the cluster certificate of the first cluster using the public key of the cluster enrollment CA to confirm that the first cluster is enrolled in the system. In an embodiment, other validations may be performed by the distributed attestation CA. For example, the processing logic may engage in a validation protocol with the first cluster, the cluster enrollment CA, the distributed attestation CA, or other entity. At block 546, the processing logic receives the data object AA certificate from the distributed attestation CA.

In an embodiment, the cluster enrollment CA is associated with a cluster enrollment CA certificate (e.g., certificate 122) issued by a common root CA (e.g., root CA server 110 or root CA 210), and the distributed attestation CA is associated with a distributed attestation CA certificate (e.g., certificate 132) issued by the common root CA.

FIG. 6A is a flow diagram of an example method 600 for sharing data objects between clusters of a distributed system, in accordance with an embodiment. Method 600 may be performed by processing logic that may comprise hardware (e.g., circuitry, dedicated logic, etc.), computer-readable instructions such as software or firmware (e.g., run on a general-purpose computing system or a dedicated machine), or a combination thereof. For instance, an example system may include a memory and a processing device coupled to the memory device to perform operations comprising the blocks of method 600. Method 600 may also be associated with a set of instructions stored on a non-transitory computer-readable medium (e.g., magnetic or optical disk, etc.). The instructions, when executed by a processing device, may cause the processing device to perform operations comprising the blocks of method 600. In an embodiment, method 600 is performed by the system of FIGS. 1A-B or components thereof (e.g., servers 110-130, clusters 140A-n, cluster servers 146A-n, secure environment 148, user device 160). In an embodiment, method 600 is performed by computing system 800 of FIG. 8. In some embodiments, blocks depicted in FIG. 6A could be performed simultaneously or in a different order than depicted. Various embodiments may include additional blocks not depicted in FIG. 6A or a subset of blocks depicted in FIG. 6A.

At block 602, processing logic associated with a first cluster of secure environments enrolls the first cluster in a distributed data object attestation system as described with reference to block 502 of method 500 and to method 530.

At block 604, the processing logic receives a request to provide the data object to a second cluster of secure environments, the request comprising a cluster certificate of the second cluster issued by the cluster enrollment CA. Aspects and embodiments described with reference to block 506 of method 500 may apply to block 604 in various embodiments, the request to provide the data object AA certificate being analogous to the request to provide the data object.

At block 606, the processing logic validates the cluster certificate of the second cluster using a public key of the cluster enrollment CA. Aspects and embodiments described with reference to block 508 of method 500 may apply to block 606 in various embodiments.

At block 608, the processing logic generates an encrypted message comprising the data object and a digital signature of the first cluster, wherein the encrypted message is encrypted using a public key indicated in the cluster certificate of the second cluster, and wherein the digital signature of the first cluster is associated with a cluster certificate of the first cluster issued by the cluster enrollment CA. Aspects and embodiments described with reference to block 510 of method 500 may apply to block 608 in various embodiments, the encrypted data object AA certificate being analogous to the encrypted data object.

At block 610, the processing logic provides, to the second cluster, the encrypted message to be decrypted using a private key of the second cluster associated with the cluster certificate of the second cluster, and to be validated using at least the public key of the cluster enrollment CA. Aspects and embodiments described with reference to block 512 of method 500 may apply to block 610 in various embodiments.

FIG. 6B is a flow diagram of an example method 620 for sharing data objects between secure environments of a distributed system, in accordance with an embodiment. Method 620 may be performed by processing logic that may comprise hardware (e.g., circuitry, dedicated logic, etc.), computer-readable instructions such as software or firmware (e.g., run on a general-purpose computing system or a dedicated machine), or a combination thereof. For instance, an example system may include a memory and a processing device coupled to the memory device to perform operations comprising the blocks of method 620. Method 620 may also be associated with a set of instructions stored on a non-transitory computer-readable medium (e.g., magnetic or optical disk, etc.). The instructions, when executed by a processing device, may cause the processing device to perform operations comprising the blocks of method 620. In an embodiment, method 620 is performed by the system of FIGS. 1A-B or components thereof (e.g., servers 110-130, clusters 140A-n, cluster servers 146A-n, secure environment 148, user device 160). In an embodiment, method 620 is performed by computing system 800 of FIG. 8. In some embodiments, blocks depicted in FIG. 6B could be performed simultaneously or in a different order than depicted. Various embodiments may include additional blocks not depicted in FIG. 6B or a subset of blocks depicted in FIG. 6B.

At block 622, processing logic associated with a first secure environment of a cluster of secure environments receives a request to provide a data object to a second secure environment of the cluster of secure environments, the request comprising a secure environment certificate of the second secure environment issued by a manufacturer of the second secure environment. Aspects and embodiments described with reference to block 506 of method 500 may apply to block 622 in various embodiments, with the first cluster being analogous to the first secure environment, the second cluster being analogous to the second secure environment, the request to provide the data object AA certificate being analogous to the request to provide the data object, and the cluster enrollment CA being analogous to the manufacturer of the second secure environment.

At block 624, the processing logic validates the secure environment certificate of the second secure environment using a public key of the manufacturer of the second secure environment. Aspects and embodiments described with reference to block 508 of method 500 may apply to block 624 in various embodiments, with the second cluster being analogous to the second secure environment and the cluster enrollment CA being analogous to the manufacturer of the second secure environment.

At block 626, the processing logic generates an encrypted message comprising the data object and a digital signature of the first secure environment, wherein the encrypted message is encrypted using a public key indicated in the secure environment certificate of the second secure environment, and wherein the digital signature of the first secure environment is associated with a secure environment certificate of the first secure environment issued by a manufacturer of the first secure environment. Aspects and embodiments described with reference to block 510 of method 500 may apply to block 626 in various embodiments, with the first cluster being analogous to the first secure environment, the second cluster being analogous to the second secure environment, the encrypted data object AA certificate being analogous to the encrypted data object, and the cluster enrollment CA being analogous to the manufacturers of the first and second secure environments.

At block 628, the processing logic provides, to the second secure environment, the encrypted message to be decrypted using a private key of the second secure environment associated with the secure environment certificate of the second secure environment, and to be validated using at least a public key of the manufacturer of the first secure environment. Aspects and embodiments described with reference to block 512 of method 500 may apply to block 628 in various embodiments, with the first cluster being analogous to the first secure environment, the second cluster being analogous to the second secure environment, the encrypted data object AA certificate being analogous to the encrypted data object, and the cluster enrollment CA being analogous to the manufacturers of the first and second secure environments.

In an embodiment, the first and second secure environments of method 620 may be associated with different clusters, rather than the same cluster.

### Computer Systems

FIG. 7 illustrates an example network server 700 with a secure environment 730 for managing data objects 731, in accordance with an embodiment. In an embodiment, network server 700 running secure environment 730 may correspond to cluster server 146A and secure environment 148 of FIG. 1B. Data objects 731 may correspond to data objects 150A-n.

As shown in FIG. 7, network server 700 may include processing device 710 that may execute operating system 720. Furthermore, processing device 710 may include one or more internal cryptographic keys 711 that may be used to encrypt and decrypt data stored in a portion of a memory that is assigned to secure environment 730. The access to the data of secure environment 730 (e.g., data objects 731) may be protected from one or more applications 740A-n and operating system 720. For example, the access to the data of the secure environment 730 may be protected by the use of one of internal cryptographic keys 711 that are internal to processing device 710 so that the access to the data is based on a hardware access as opposed to a software access. Operating system 720 may be associated with a first privilege level and secure environment 730 and applications 740A-n may be associated with a second privilege level where the first privilege level of the operating system is more privileged than the second privilege level of the various applications that are run on operating system 720 (e.g., the more privileged level allows access to more resources of the network server than the less privileged level). Thus, operating system 720 may be allowed access to resources of applications 740A-n. However, since access to the data of the secure environment 730 is based on the use of an internal cryptographic key 711 of processing device 710, operating system 720 may not be able to access data objects 731 despite having a more privileged level of access than secure environment 730. The master key that is used to decrypt data at the storage resource may be an internal cryptographic key 711.

In operation, a client device (e.g., user device 160) may request an operation to be performed on a data object of data objects 731 or may request an attestation of data object attributes of data objects 731. Due to the data object's location in secure environment 730, the data object may be encrypted and protected by the use of an internal cryptographic key 711 (i.e., the master key) of processing device 710. Secure environment 730 may subsequently use an instruction so that processing device 710 may use one of its internal cryptographic keys 711 to decrypt the data of secure environment 730 and to retrieve the data. Subsequently, a cryptographic operation such as operating on the data object or generating an attestation may then be performed by processing device 710 and then the output of the cryptographic operation may be provided to the client device. In some embodiments, internal cryptographic key 711 may be combined with additional information (e.g., an identifier of the data object) to generate the master key for secure environment 730 that is used to decrypt and/or encrypt data objects 731. Thus, since processing device 710 uses its internal cryptographic key 711 to decrypt data and to perform the cryptographic operation, the data objects 731 and other data may not be exposed external to processing device 710. Client devices may thus be assured that data objects managed by secure environment 730 have not been tampered with at network server 700 and may therefore trust attestations received from the cluster.

FIG. 8 is a block diagram illustrating an example computer system 800, in accordance with implementations of the present disclosure. Computer system 800 may correspond to servers 110-130, clusters 140A-n, cluster servers 146A-n, secure environment 148, or user device 160, as described with respect to FIGS. 1A-B. Computer system 800 may also correspond to network server 700, described with respect to FIG. 7. Computer system 800 may operate in the capacity of a server or an endpoint machine in endpoint-server network environment, or as a peer machine in a peer-to-peer (or distributed) network environment. The machine may be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 800 includes processing device 802 (e.g., one or more processors or cores), main memory 804 (e.g., read-only memory (ROM), flash memory, dynamic random access memory (DRAM) such as synchronous DRAM (SDRAM), double data rate (DDR SDRAM), or DRAM (RDRAM), etc.), static memory 806 (e.g., flash memory, static random access memory (SRAM), etc.), and data storage device 808, which communicate with each other via bus 810.

Processing device 802 represents one or more general-purpose processing devices such as a microprocessor, central processing unit, or the like. More particularly, processing device 802 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. Processing device 802 is configured to execute instructions 812 (e.g., for cryptographic attestation of data object attributes in a distributed system) for performing the operations discussed herein.

Computer system 800 may further include network interface device 814. Computer system 800 also may include display device 816 (e.g., a liquid crystal display (LCD) or a cathode ray tube (CRT)), alphanumeric input device 818 (e.g., a keyboard, and alphanumeric keyboard, a motion sensing input device, touch screen), cursor control device 820 (e.g., a mouse), and signal generation device 822 (e.g., a speaker). In some embodiments, computer system 800 may not include display device 816, alphanumeric input device 818, and/or cursor control device 820 (e.g., in a headless configuration).

Data storage device 808 may include a non-transitory machine-readable storage medium 824 (also computer-readable storage medium) on which is stored one or more sets of instructions 812 (e.g., for cryptographic attestation of data object attributes in a distributed system) embodying any one or more of the methodologies or functions described herein. Instructions 812 may also reside, completely or at least partially, within main memory 804 or within the processing device 802 during execution thereof by computer system 800, main memory 804 and processing device 802 also constituting machine-readable storage media. Instructions 812 may further be transmitted or received over network 826 via network interface device 814.

In one implementation, instructions 812 include instructions for cryptographic attestation of data object attributes in a distributed system, as described herein. While computer-readable storage medium 824 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing certain terms may refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

As used in this application, the term “or” is intended to mean an inclusive “or” rather than an exclusive “or.” That is, unless specified otherwise, or clear from context, “A or B” is intended to mean any of the natural inclusive permutations (e.g., A and B, A and not B, B and not A). In addition, the articles “a” and “an” as used in this application and the appended claims should generally be construed to mean “one or more” unless specified otherwise or clear from context to be directed to a singular form.

Furthermore, the terms “one implementation,” “one embodiment,” “an implementation,” “an embodiment,” or similar mean that a particular feature, structure, or characteristic described in connection with the implementation and/or embodiment is included in at least one implementation and/or embodiment. Thus, the appearances of the phrase “in one implementation,” or “in an implementation,” in various places throughout this specification can, but are not necessarily, referring to the same implementation, depending on the circumstances. Furthermore, the particular features, structures, or characteristics may be combined in any suitable manner in one or more implementations.

What is claimed is:

1. A method comprising:
receiving, by a processing device associated with a first cluster of secure environments, a request to provide a data object attestation authority certificate to a second cluster of secure environments, the request comprising a cluster certificate of the second cluster issued by a cluster enrollment certificate authority (CA);
validating the cluster certificate of the second cluster using a public key of the cluster enrollment CA;
generating an encrypted message comprising the data object attestation authority certificate and a digital signature of the first cluster, wherein the encrypted message is encrypted using a public key indicated in the cluster certificate of the second cluster, and wherein the digital signature of the first cluster is associated with a cluster certificate of the first cluster issued by the cluster enrollment CA; and
providing, to the second cluster, the encrypted message to be decrypted using a private key of the second cluster associated with the cluster certificate of the second cluster, and to be validated using at least the public key of the cluster enrollment CA.

2. The method of claim 1, further comprising:
prior to generating the encrypted message, enrolling the first cluster in a distributed data object attestation system, wherein enrolling the first cluster further comprises:
generating a request for the cluster certificate of the first cluster, wherein the request comprises a public key of the first cluster and one or more secure environment certificates each associated with a manufacturer of a respective secure environment of the first cluster;
providing the request to the cluster enrollment CA to be validated using one or more manufacturer public keys each associated with a respective secure environment certificate of the one or more secure environment certificates; and
receiving the cluster certificate of the first cluster from the cluster enrollment CA.

3. The method of claim 1, further comprising:
prior to generating the encrypted message, obtaining the data object attestation authority certificate from a distributed attestation CA, wherein obtaining the data object attestation authority certificate further comprises:
generating a request for the data object attestation authority certificate, the request comprising the cluster certificate of the first cluster;
providing the request to the distributed attestation CA to be validated using the public key of the cluster enrollment CA; and
receiving the data object attestation authority certificate from the distributed attestation CA.

4. The method of claim 3, wherein:
the cluster enrollment CA is associated with a cluster enrollment CA certificate issued by a common root CA; and
the distributed attestation CA is associated with a distributed attestation CA certificate issued by the common root CA.

5. The method of claim 1, further comprising:
receiving a request of an entity to provide an attestation for a data object, the request comprising an identifier of the data object;
identifying a storage location of the data object to be the first cluster;
identifying one or more attributes of the data object;
generating the attestation, wherein the attestation comprises the identifier of the data object, the one or more attributes of the data object, and a digital signature associated with the data object attestation authority certificate; and
providing the attestation to the entity.

6. The method of claim 5, wherein the data object comprises one or more of: a permissible usage attribute indicating for what purposes the data object may be used, an origination attribute indicating whether the data object was generated in a secure environment of the first cluster, or an export attribute indicating whether the data object may be exported from the first cluster.

7. The method of claim 1, further comprising:
receiving a request of an entity to provide an attestation for a data object, the request comprising an identifier of the data object;
identifying a storage location of the data object to be the second cluster;
obtaining one or more attributes of the data object from the second cluster;
generating the attestation, wherein the attestation comprises the identifier of the data object, the one or more attributes of the data object, and a digital signature associated with the data object attestation authority certificate; and
providing the attestation to the entity.

8. The method of claim 1, wherein the encrypted message is to be further validated using at least the cluster certificate of the first cluster.

9. A system comprising:
a memory device; and
a processing device coupled to the memory device, the processing device to perform operations comprising:
receiving, at a first cluster of secure environments, a request to provide a data object attestation authority certificate to a second cluster of secure environments, the request comprising a cluster certificate of the second cluster issued by a cluster enrollment certificate authority (CA);
validating the cluster certificate of the second cluster using a public key of the cluster enrollment CA;
generating an encrypted message comprising the data object attestation authority certificate and a digital signature of the first cluster, wherein the encrypted message is encrypted using a public key indicated in the cluster certificate of the second cluster, and wherein the digital signature of the first cluster is associated with a cluster certificate of the first cluster issued by the cluster enrollment CA; and
providing, to the second cluster, the encrypted message to be decrypted using a private key of the second cluster associated with the cluster certificate of the second cluster, and to be validated using at least the public key of the cluster enrollment CA.

10. The system of claim 9, the operations further comprising:
prior to generating the encrypted message, enrolling the first cluster in a distributed data object attestation system, wherein enrolling the first cluster further comprises:
generating a request for the cluster certificate of the first cluster, wherein the request comprises a public key of the first cluster and one or more secure environment certificates each associated with a manufacturer of a respective secure environment of the first cluster;
providing the request to the cluster enrollment CA to be validated using one or more manufacturer public keys each associated with a respective secure environment certificate of the one or more secure environment certificates; and
receiving the cluster certificate of the first cluster from the cluster enrollment CA.

11. The system of claim 9, the operations further comprising:
prior to generating the encrypted message, obtaining the data object attestation authority certificate from a distributed attestation CA, wherein obtaining the data object attestation authority certificate further comprises:
generating a request for the data object attestation authority certificate, the request comprising the cluster certificate of the first cluster;
providing the request to the distributed attestation CA to be validated using the public key of the cluster enrollment CA; and
receiving the data object attestation authority certificate from the distributed attestation CA.

12. The system of claim 11, wherein:
the cluster enrollment CA is associated with a cluster enrollment CA certificate issued by a common root CA; and
the distributed attestation CA is associated with a distributed attestation CA certificate issued by the common root CA.

13. The system of claim 9, the operations further comprising:
receiving a request of an entity to provide an attestation for a data object, the request comprising an identifier of the data object;
identifying a storage location of the data object to be the first cluster;
identifying one or more attributes of the data object;
generating the attestation, wherein the attestation comprises the identifier of the data object, the one or more attributes of the data object, and a digital signature associated with the data object attestation authority certificate; and
providing the attestation to the entity.

14. The system of claim 13, wherein the data object comprises one or more of: a permissible usage attribute indicating for what purposes the data object may be used, an origination attribute indicating whether the data object was generated in a secure environment of the first cluster, or an export attribute indicating whether the data object may be exported from the first cluster.

15. A non-transitory computer-readable medium comprising instructions that, when executed by a processing device, cause the processing device to perform operations comprising:
receiving, at a first cluster of secure environments, a request to provide a data object attestation authority certificate to a second cluster of secure environments, the request comprising a cluster certificate of the second cluster issued by a cluster enrollment certificate authority (CA);
validating the cluster certificate of the second cluster using a public key of the cluster enrollment CA;
generating an encrypted message comprising the data object attestation authority certificate and a digital signature of the first cluster, wherein the encrypted message is encrypted using a public key indicated in the cluster certificate of the second cluster, and wherein the digital signature of the first cluster is associated with a cluster certificate of the first cluster issued by the cluster enrollment CA; and
providing, to the second cluster, the encrypted message to be decrypted using a private key of the second cluster associated with the cluster certificate of the second cluster, and to be validated using at least the public key of the cluster enrollment CA.

16. The non-transitory computer-readable medium of claim 15, the operations further comprising:
prior to generating the encrypted message, enrolling the first cluster in a distributed data object attestation system, wherein enrolling the first cluster further comprises:
generating a request for the cluster certificate of the first cluster, wherein the request comprises a public key of the first cluster and one or more secure environment certificates each associated with a manufacturer of a respective secure environment of the first cluster;
providing the request to the cluster enrollment CA to be validated using one or more manufacturer public keys each associated with a respective secure environment certificate of the one or more secure environment certificates; and
receiving the cluster certificate of the first cluster from the cluster enrollment CA.

17. The non-transitory computer-readable medium of claim 15, the operations further comprising:
prior to generating the encrypted message, obtaining the data object attestation authority certificate from a distributed attestation CA, wherein obtaining the data object attestation authority certificate further comprises:
generating a request for the data object attestation authority certificate, the request comprising the cluster certificate of the first cluster;
providing the request to the distributed attestation CA to be validated using the public key of the cluster enrollment CA; and
receiving the data object attestation authority certificate from the distributed attestation CA.

18. The non-transitory computer-readable medium of claim 17, wherein:
the cluster enrollment CA is associated with a cluster enrollment CA certificate issued by a common root CA; and
the distributed attestation CA is associated with a distributed attestation CA certificate issued by the common root CA.

19. The non-transitory computer-readable medium of claim 15, the operations further comprising:
receiving a request of an entity to provide an attestation for a data object, the request comprising an identifier of the data object;
identifying a storage location of the data object to be the second cluster;
obtaining one or more attributes of the data object from the second cluster;
generating the attestation, wherein the attestation comprises the identifier of the data object, the one or more attributes of the data object, and a digital signature associated with the data object attestation authority certificate; and
providing the attestation to the entity.

20. The non-transitory computer-readable medium of claim 15, wherein the encrypted message is to be further validated using at least the cluster certificate of the first cluster.
